(19) United States
(12) Patent Application Publication
(10) Pub. No.: US 2013/0179207 A1
(43) Pub. Date: Jul. 11, 2013

(54) Method and Apparatus for High Performance Design of a Project

(71) Applicants: Doris S. Perez Rodriguez, Arlington Heights, IL (US); Jeffrey J. McCarthy, Chicago, IL (US); Normunds Krickis, Brooklyn, NY (US)

(72) Inventors: Doris S. Perez Rodriguez, Arlington Heights, IL (US); Jeffrey J. McCarthy, Chicago, IL (US); Normunds Krickis, Brooklyn, NY (US)

(73) Assignee: SKIDMORE OWINGS & MERRILL LLP, New York, NY (US)

(21) Appl. No.: 13/345,349

(22) Filed: Jan. 6, 2012

(51) Int. Cl. G06Q 10/06

(52) U.S. Cl. 705/7.15

(57) ABSTRACT

Method, apparatus, and program for high performance design of a project. A goal of the project to meet at least one sustainability criterion is first received. A design strategy is then associated with the goal of the project in accordance with the at least one sustainability criterion. The design strategy is created based on a common design approach. A design task is further associated with the design strategy at each phase of the project in accordance with the at least one sustainability criterion. The design task is created to implement the design strategy. A goal metric for the at least one sustainability criterion at each phase of the project is then dynamically calculated based on information of the project from a database. Eventually, progress of meeting the at least one sustainability criterion is dynamically updated based on the calculated goal metric.

### BACKGROUND

1. Technical Field

The present teaching relates generally to architecture design, and in particular, relates to methods, apparatuses, and programming for high performance design of a project.

2. Discussion of Technical Background

Sustainable architecture design is an energy and ecologically conscious approach to the design of the built environment and includes environmentally conscious design techniques in the field of architecture. Sustainable architecture is framed by the larger discussion of sustainability and the pressing economic and civic issues of our world. In the broad context, sustainable architecture seeks to minimize the negative environmental impact of buildings by enhancing efficiency and moderation in the use of materials, energy, and development space.

On the other hand, as architects and engineers continue to embrace technological advances in computer-aided design via parametric and building-information-modeling processes, the use of automated building analysis programs has been gaining popularity. For example, Parametric and Building Information Modeling (BIM) programs tie physical and informational characteristics to components of a building design, thereby creating a building model with relational physical properties; instead of just a building schematic or a 3D model as an assembly of connected lines. The building information model can be fed into a simulation or analysis program to determine the building's behavioral patterns. For example, a building information model may be analyzed to determine how sunlight will illuminate the building throughout a day or to simulate energy consumption, or simulate radiant heat (thermal) loss or gain through a given assembly of wall materials comprised of actual, codified, conductance and resistance values.

Therefore, there is a need to combine the techniques of sustainable architecture design and computer-aided architecture design to provide an effective tool for performing high performance design of an architecture project.

### SUMMARY

The present teaching relates to methods, apparatuses, and programming for high performance design of a project.

In one example, a method, implemented on at least one machine, each of which has at least one processor, storage, and a communication platform connected to a network for high performance design of a project. A goal of the project to meet at least one sustainability criterion is first received by a project goal module implemented by a processor. A design strategy is then associated with the goal of the project in accordance with the at least one sustainability criterion by a design strategy module implemented by the processor. The design strategy is created based on a common design approach. A design task is further associated with the design strategy at each phase of the project in accordance with the at least one sustainability criterion by a design task module implemented by the processor. The design task is created to implement the design strategy. A goal metric for the at least one sustainability criterion at each phase of the project is then dynamically calculated based on information of the project from a database by a performance calculator implemented by the processor. Eventually, progress of meeting the at least one sustainability criterion is dynamically updated based on the calculated goal metric by the performance calculator.

In a different example, an apparatus for high performance design of a project is presented, which includes a project goal module, a design strategy module, a design task module, and a performance calculator, each of which is implemented by a processor. The project goal module is configured to receive a goal of the project to meet at least one sustainability criterion. The design strategy module is configured to associate a design strategy with the goal of the project in accordance with the at least one sustainability criterion. The design strategy is created based on a common design approach. The design task module is configured to associate a design task with the design strategy at each phase of the project in accordance with the at least one sustainability criterion. The design task is created to implement the design strategy. The performance calculator is configured to dynamically calculate a goal metric for the at least one sustainability criterion at each phase of the project based on information of the project from a database. The performance calculator is also configured to dynamically update progress of meeting the at least one sustainability criterion based on the calculated goal metric.

Other concepts relate to software for high performance design of a project. A software product, in accord with this concept, includes at least one machine-readable non-transitory medium and information carried by the medium. The information carried by the medium may be executable program code data regarding parameters in association with a request or one or more operational parameters, such as information related to a user, a request, or a social group, etc.

In one example, a machine readable and non-transitory medium having information recorded thereon for high performance design of a project recorded thereon, wherein the information, when read by the machine, causes the machine to perform a series of steps. A goal of the project to meet at least one sustainability criterion is first received. A design strategy is then associated with the goal of the project in accordance with the at least one sustainability criterion. The design strategy is created based on a common design approach. A design task is further associated with the design strategy at each phase of the project in accordance with the at least one sustainability criterion. The design task is created to implement the design strategy. A goal metric for the at least one sustainability criterion at each phase of the project is then dynamically calculated based on information of the project from a database. Eventually, progress of meeting the at least one sustainability criterion is dynamically updated based on the calculated goal metric.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, apparatuses, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 depicts an exemplary embodiment of a networked environment in which high performance design is applied, according to an embodiment of the present teaching;

FIG. 2 depicts an exemplary diagram of an apparatus for high performance design shown in FIG. 1, according to an embodiment of the present teaching;

FIG. 3 is a depiction of an exemplary relationship between project goals, design strategies, and design tasks, according to an embodiment of the present teaching;

FIGS. 4a and 4b are depictions of exemplary user interfaces of a project goal module of the apparatus for high performance design shown in FIG. 2, according to an embodiment of the present teaching;

FIGS. 5a and 5b are depictions of exemplary user interfaces of a design strategy module of the apparatus for high performance design shown in FIG. 2, according to an embodiment of the present teaching;

FIG. 6 is a depiction of an exemplary user interface of a design task module of the apparatus for high performance design shown in FIG. 2, according to an embodiment of the present teaching;

FIG. 7 depicts exemplary information of a project for a performance calculator of the apparatus for high performance design shown in FIG. 2, according to an embodiment of the present teaching;

FIG. 8 is a flowchart of an exemplary process for high performance design of a project, according to an embodiment of the present teaching;

FIG. 9 is a flowchart of a more detailed exemplary process for high performance design shown in FIG. 8, according to an embodiment of the present teaching; and

FIG. 10 depicts a general computer architecture on which the present teaching can be implemented.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, systems, components, and/or circuitry have been described at a relatively high-level, without detail, in order to avoid unnecessarily obscuring aspects of the present teachings.

The present disclosure describes method, apparatus, and programming aspects of high performance design of a project. The design method and apparatus as disclosed herein aim at the implementation of a high performance design methodology, in particular, the sustainable architecture design, in order to make the architecture project design more efficient and effective. Such method and apparatus benefit users in several ways: for example, it tracks the efficiencies of a building design and technology in supporting sustainability metrics through the life of the project; it contains a framework to identify, implement, monitor and measure best design practices within any geographic location and building type, and supports applicable local and international codes, policies and regulations in order to support the attainment of any applicable sustainability design certification; it has the ability to assign and track tasks per project phase; it has the ability to track, dynamically calculate, and display project metrics comparing goals for water, energy and carbon reductions against actual project metrics per phase; it has the abilities to associate design strategies to project goals and to associate tasks per phase to design strategies. Additional advantages and novel features will be set forth in part in the description which follows, and in part will become apparent to those skilled in the art upon examination of the following and the accompanying drawings or may be learned by production or operation of the examples.

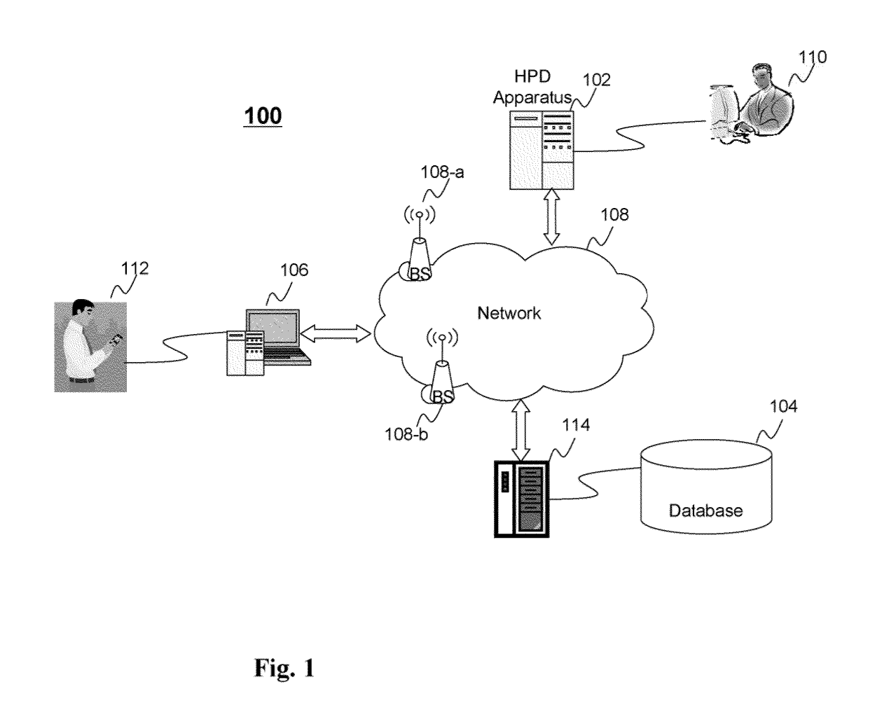

FIG. 1 depicts a networked environment in which high performance design is applied, according to an embodiment of the present teaching. The exemplary system 100 includes an apparatus 102 for high performance design (HPD), a database 104, one or more client machines 106, and a network 108. The network 108 may be a single network or a combination of different networks. For example, the network 108 may be a local area network (LAN), a wide area network (WAN), a public network, a private network, a proprietary network, a Public Telephone Switched Network (PSTN), the Internet, a wireless network, a virtual network, or any combination thereof. The network 108 may also include various network access points, e.g., wired or wireless access points such as base stations or Internet exchange points 108-a, . . . , 108-b, through which the database 104, the HPD apparatus 102, and the client machines 106 may connect to the network 108 in order to transmit information via the network 108.

The database 104 may be set up on one or more servers 114 for providing and storing information related to high performance design. The information includes, for example, the project context and site location, project climatic data, project classification data, project statistic data, project structure data, code/regulation data, building information model, etc. The information stored in this database 104 may be related to multiple projects, such as ongoing or completed building, city, or interior design projects. For ongoing projects, the related information may be periodically or real-time updated. In one example, the climatic data may be manually or automatically collected from a climate repository near the location of the project. In another example, the code/regulation data may include any local code, policy, or regulation for obtaining a sustainable design certification and may be dynamically updated once the code, policy or regulation is amended. In still another example, real-time or historical traffic data may be retrieved from a traffic repository near the location of the project. For completed projects, the related information may be stored permanently or temporarily for a predetermined period. It is understood that the database 104 may be provided either on a single server having one or more databases or on multiple connected or unconnected servers.

The HPD apparatus 102 and client machines 106 may be autonomous physical machines, such as a server, a workstation, a desktop or laptop computer, a netbook, a tablet, a smart phone, or any other suitable machine. The HPD apparatus 102 may be responsible for receiving project goals from users 110 to meet certain sustainability criteria and retrieving information of the projects from the database 104 based on the received project goals. The sustainability criteria for high preface designs include, for example, energy, water, waste, human comfort, materials, certification, carbon, and any combination thereof. Each project may be divided into various phases, such as but not limited to, concept phase, schematic design phase, design development phase, construction phase, etc. Using the HPD apparatus 102, various design strategies may be automatically decided based on the project goals and/or manually selected by the users 110 and may be associated with each project goal. Each design strategy may be defined in detail and categorized in several areas, i.e., based on common design approaches, such as reduction, absorption, reclamation, generation, and design/construction. The status of each design strategy may be monitored through the various phases of the project, and its usability may be recorded. Using the HPD apparatus 102, one or more design tasks, assigned per phase, to successfully implement the design strategies and accomplish the project goals may be automatically decided based on the project goals and/or manually selected by the users 110 and may be associated with each design strategy. The status of each design task may be also monitored through the various phases of the project, and its progress may be recorded. Moreover, the goal metric for indicating the performance may be calculated for each criterion and tracked and compared to the received project goals. The calculation for each criterion may be made based on a variety of factors and disciplines, including the information retrieved from the database 104 and supporting information provided by the users 110.

Project clients 112 may get access, though the client machines 106, to the entire or parts of the HPD apparatus 102 in order to review and track the progress of the high performance design of their projects. The project clients 112 may also track sign-off meetings and record client awareness on the HPD apparatus 102.

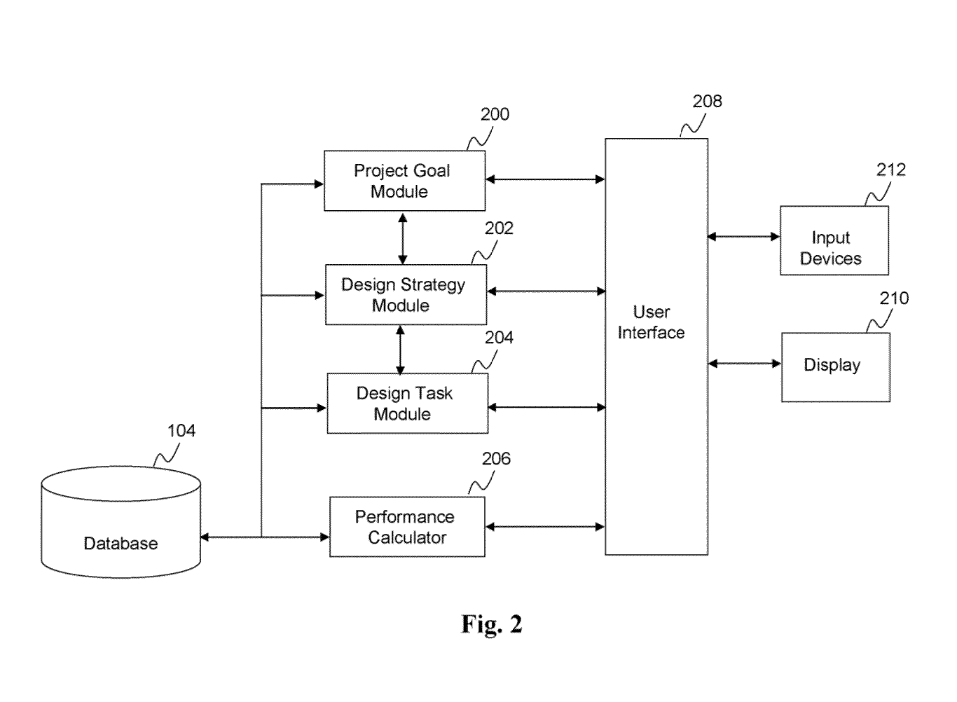

FIG. 2 depicts an exemplary block diagram of the apparatus 102, according to an embodiment of the present teaching. In this exemplary embodiment, the apparatus 102 includes a project goal module 200, a design strategy module 202, a design task module 204, and a performance calculator 206, each of which is implemented by one or more processors of the apparatus 102 in the form of, for example, executable code and associated data. The apparatus 102 may further include a user interface 208, such as a graphic user interface in the form of a web-based or non-web-based application, which may be presented on a display 210. The user interface 208 may be also responsible for receiving user inputs through any suitable input device 212 of the apparatus 102, for example, a keyboard, mouse, keypad, microphone, etc.

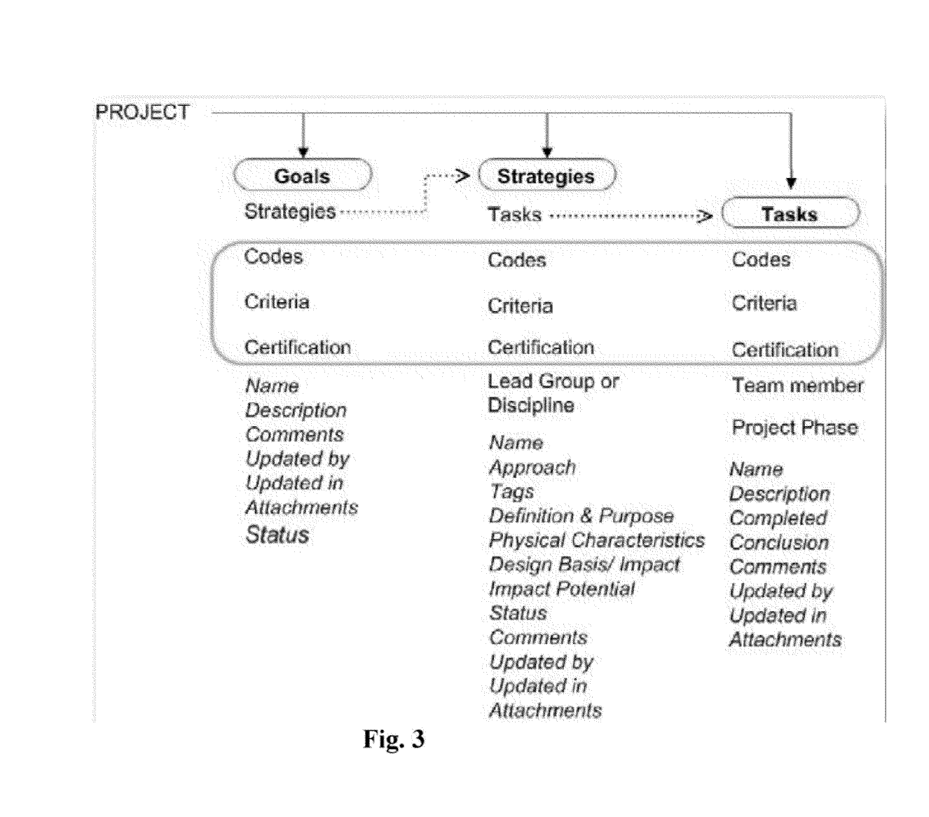

In this example, the project goal module 200 is configured to receive a goal of the project to meet at least one sustainability criterion through the user interface 208. As described above, the sustainability criteria include energy, water, waste, human comfort, materials, certification, carbon, and any combination thereof. For example, one of the project goals may be reducing the carbon emission below a threshold level as required by local regulations. It is understood that more than one goal may be received for the same project and that for each project goal, more than one sustainability criterion may be applied. Referring to FIG. 3, in addition to the sustainability criteria, each project goal may be set up to comply with one or more codes, policies, or regulations for sustainable design and to aim at obtaining one or more sustainable design certifications. Each goal of the project may include name, description, comments, most recent updated user and time, attachment, and status.

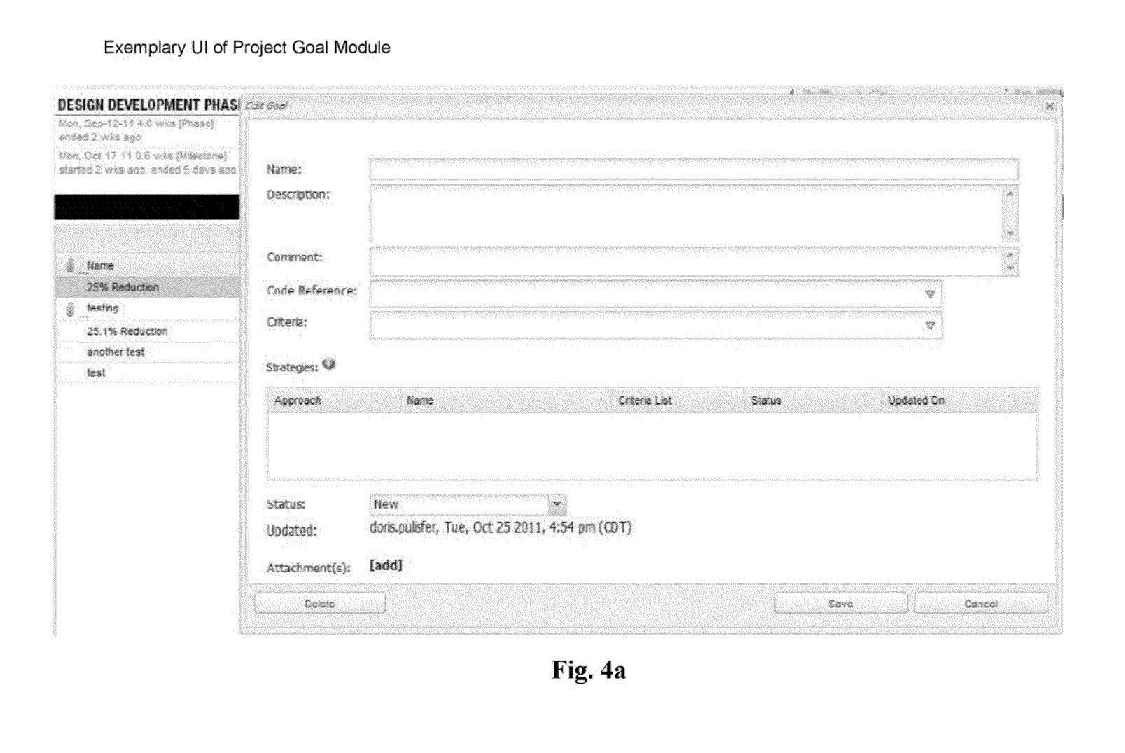

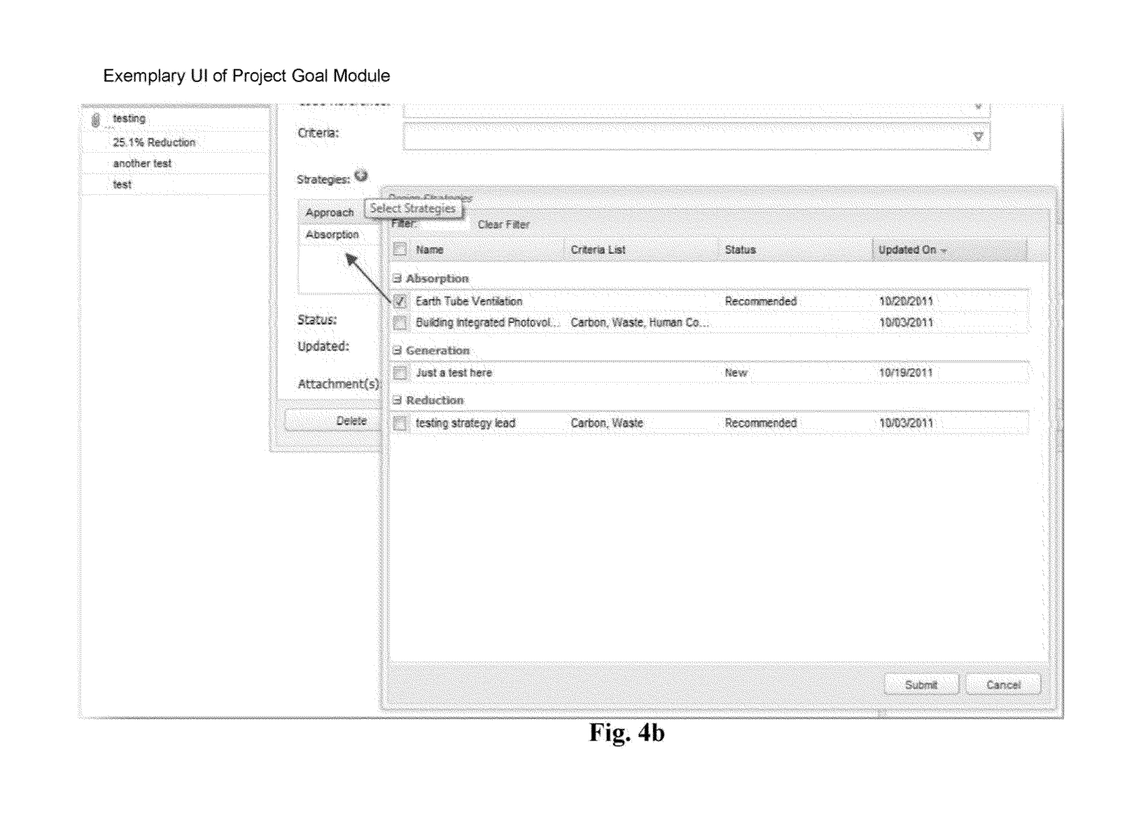

FIGS. 4a and 4b show exemplary user interfaces of the project goal module 200. In FIG. 4a, a project goal may be created or modified through a web-based form. Each of the name, description, comments, code reference, criteria, strategies, status, and attachment may be an input field of the form. A user then may fill in each field by selecting from existing values or creating its own value. The code reference field may be a drop-down list of suitable codes, policies, or regulations that may be dynamically presented based on, for example, the location of the project. In one example, for a project in the United States, the drop-down list may include International Energy Consideration Code (IECC) and International Green Construction Code (IGCC). In another example, for a project located in China, the drop-down list may change to, for example, GB 50189-2005 Design Standard for Energy Efficiency of Public Buildings and JFG-286-2007 Energy Efficiency Evaluation in Beijing. The status field may be a drop-down list of possible status of the project goal, such as new, recommended, pending approval, client approved, and dismissed. The criteria field may be a drop-down list of the sustainability criteria as noted above. The updated field may be a non-editable field and may display the user and time of the most recent update. The strategies field may be responsible for receiving the user's input regarding the design strategies to be associated with a particular project goal. In one example, as shown in FIG. 4b, the user may select one or more design strategies that have been created to support the project sustainability goals. It is understood that in other examples, the project goals may be created through other types of user interface, such as speech recognition, script, interactive user interface, or command line. It is also understood that one or more common project goals may be predefined as standard templates such that users may create new project goals by selecting from the existing templates.

Referring back to FIG. 2, the design strategy module 202 is operatively coupled to the project goal module 200. In this example, the design strategy module 202 is configured to associate a design strategy with the goal of the project in accordance with the at least one sustainability criterion. The design strategy is created based on a common design approach. The common design approaches may be common building design and technology performance approaches to meet certain sustainability criteria, including for example, reduction, absorption, reclamation, generation, and design/construction. Each design strategy may be classified based on the common design approach. Referring to FIG. 3, in addition to the sustainability criteria, each design strategy may be set up to comply with one or more codes, policies, or regulations for sustainable design and to aim at obtaining one or more sustainable design certifications. Each design strategy may include lead group or discipline, name, approach, tags, definition and purpose, physical characteristics, design basis/impact, impact potential, status, comments, most recent updated user and time, and attachments.

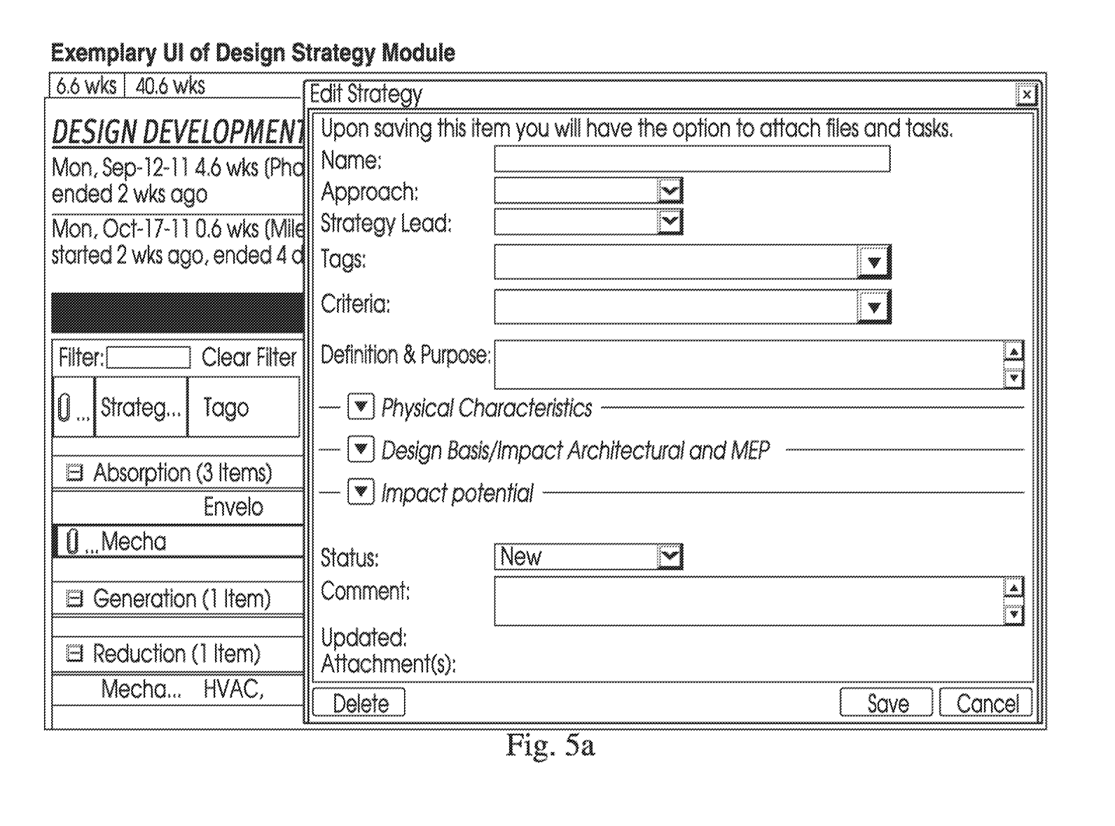

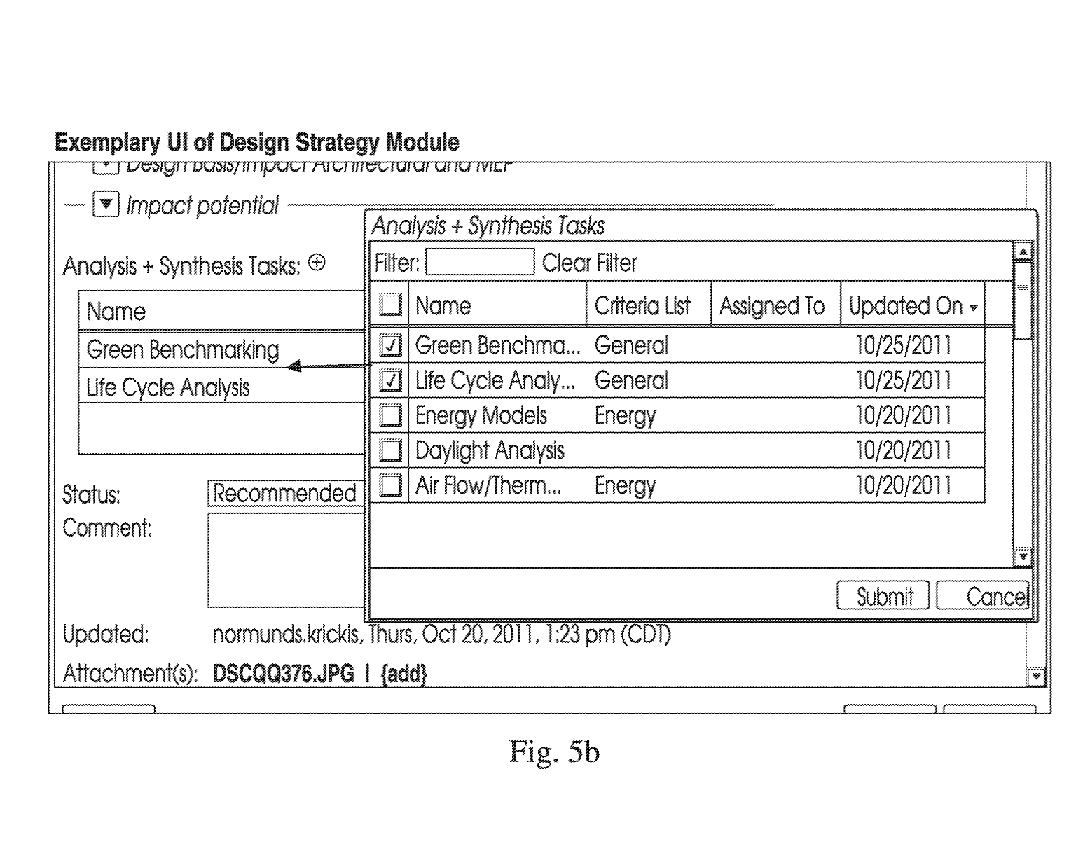

FIGS. 5a and 5b show exemplary user interfaces of the design strategy module 202. In FIG. 5a, a design strategy may be created or modified through a web-based form. Each of the name, approach, strategy lead, tags, criterion, definition and purpose, physical characteristics, design basis/impact, impact potential, status, comments, and attachments may be an input field of the form. A user then may fill in each field by selecting from existing values or creating its own value. The approach field may be a drop-down list of suitable approaches as noted above. The tags field may be a drop-down list of possible status of the design strategy, such as architecture, civil engineering, electrical engineering, fire protection, interior design, landscape, lighting, mechanical engineering, plumbing engineering, structural engineering, life/safety engineering, etc. The criteria field may be a drop-down list of the sustainability criteria as noted above. The status field may be a drop-down list of possible status of the design strategies, such as new, recommended, pending approval, client approved, and dismissed. The updated field may be a non-editable field and may display the user and time of the most recent update. As shown in FIG. 5b, the tasks field may be responsible for receiving the user's input regarding the design tasks to be associated with a particular design strategy. The user may select one or more design tasks that have been created to implement the design strategy. It is understood that in other examples, the design strategies may be created through other types of user interface, such as speech recognition, script, interactive user interface, or command line. It is also understood that one or more common design strategies may be predefined as standard templates such that users may create new design strategies by selecting from the existing templates. For example, the standard templates for absorption design strategies may include building integrated photovoltaic and earth tube ventilation.

As noted above with respect to FIG. 4b, one or more design strategies may be associated with a project goal in accordance with one or more sustainability criteria. For example, building integrated photovoltaic may be an absorption design strategy that is created to meet the carbon, waste, human comfort, and general criteria. For a project goal of reducing carbon emission, the building integrated photovoltaic may be associated with the project goal in an automatic manner by the design strategy module 202 or in a manual manner by the users. The association may also be done in a semi-automatic manner where building integrated photovoltaic is listed as one of the possible design strategies for the users to select. The association may be performed taking consideration into other factors, such as the status of each design strategy, e.g., recommended, new, client approved, etc., and the environmental benefit level. Moreover, economic impact, i.e., cost, for implementing each design strategy may be determined by the design strategy module 202 and presented on the display 210 to the users. Each design strategy then may be graded based on overall environmental, economic, and human comfort impacts. For example, the earth tube ventilation design strategy may be graded as medium in economic impact and low in environmental benefit.

Referring back to FIG. 2, the design task module 204 is operatively coupled to the design strategy module 202. In this example, the design task module 204 is configured to associate a design task with the design strategy at each phase of the project in accordance with the at least one sustainability criterion. The design task may be created to implement the design strategy. The design task may include any necessary analysis and synthesis tasks, assigned per phase, to successfully implement high performance design strategies and accomplish sustainability goals. Referring to FIG. 3, in addition to the sustainability criteria, each design task may be set up to comply with one or more codes, policies, or regulations for sustainable design and to aim at obtaining one or more sustainable design certifications. Each design task may include team member, project phase, name, description, completeness, conclusion, comments, most recent updated user and time, and attachments.

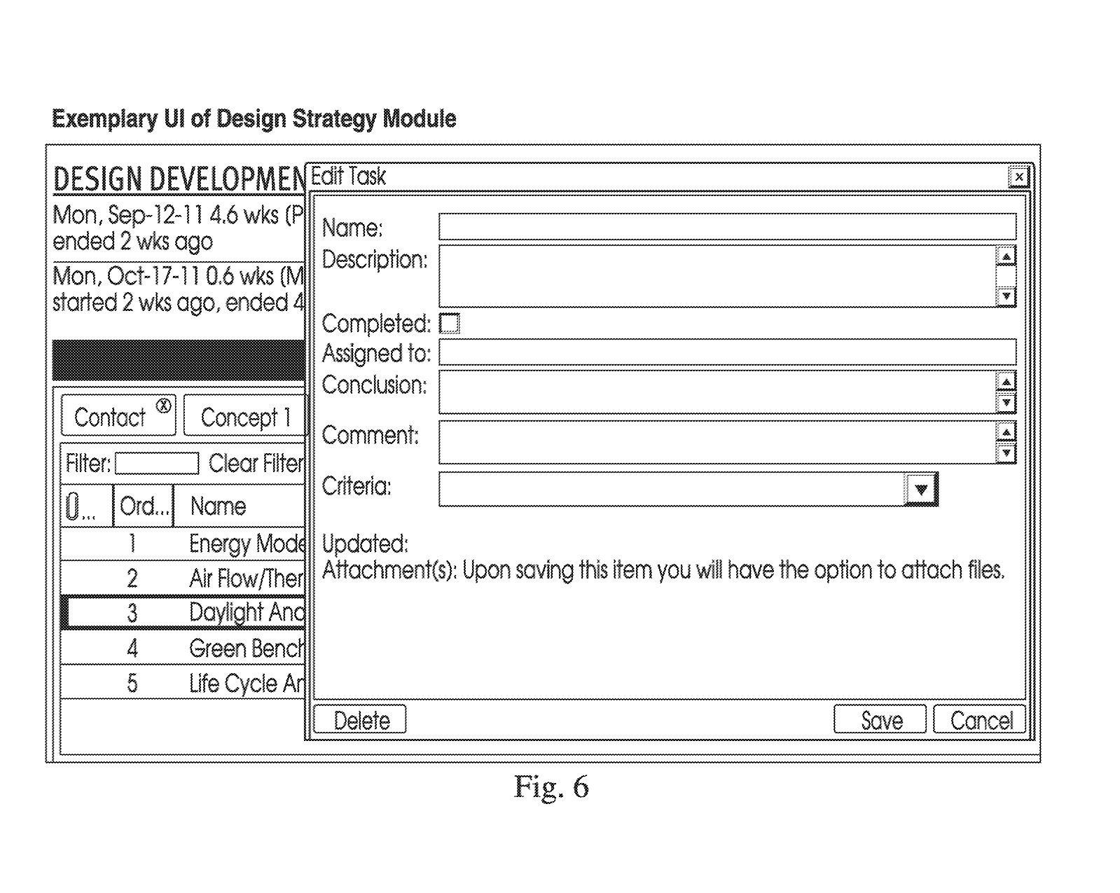

FIG. 6 shows an exemplary user interface of the design task module 204. In this example, a design task may be created or modified through a web-based form. Each of the name, description, completeness, team member, conclusion, comments, criterion, and attachments may be an input field of the form. A user then may fill in each field by selecting from existing values or creating its own value. The criteria field may be a drop-down list of the sustainability criteria as noted above. Once a team member is assigned to a design task, a notification such as an email may be automatically generated and sent to the assigned team member indicating the assignment at each project phase. The updated field may be a non-editable field and may display the user and time of the most recent update. It is understood that in other examples, the design tasks may be created through other types of user interface, such as speech recognition, script, interactive user interface, or command line. It is also understood that one or more common design tasks may be predefined as standard templates such that users may create new design tasks by selecting from the existing templates. For example, the standard templates of design tasks may include water efficient system design, solar radiation studies, detailed renewable energy assessment, thermal comfort analysis, energy models, air flow/thermal analysis, daylight analysis, green benchmarking, life cycle analysis, etc.

As noted above with respect to FIG. 5b, one or more design tasks may be associated with a design strategy in accordance with one or more sustainability criterion. For example, green benchmarking and life cycle analysis tasks may be associated with the building integrated photovoltaic design strategy as they are all designated to meet the general sustainability criterion. In this example, the design tasks are created and associated on a project phase basis, and different design tasks may be associated with the same design strategy at different project phases if necessary. Moreover, the completeness of each design task at each project phase may be determined and tracked by the design task module 204 and may be presented on the display 210 of the apparatus 102 to the users.

Referring back to FIG. 2, the performance calculator 206 is operatively coupled to the project goal module 200, the design strategy module 202, the design task module 204 and the database 104. In this example, the performance calculator 206 is configured to dynamically calculate a goal metric for the at least one sustainability criterion at each phase of the project based on information of the project from the database 104. Although the database 104 is described as being set up on a server 114 remote from the apparatus 102, it is understood that the database 104 may be part of the apparatus 102 in other examples. The calculation for each criterion may be based on a variety of factors and disciplines, including information of the project retrieved from the database 104 and additional information provided by the users. The performance calculator 206 is also configured to dynamically update progress of meeting the at least one sustainability criterion based on the calculated goal metric. The progress may be represented in the form of, for example, percentage ratio, absolute value, graphics or diagram. The project goals and their associated design strategies and the progress of meeting the sustainability criterion may be presented on the display 210 of the apparatus 102 to the users. For example, the performance calculations for each sustainability criterion may be tracked and compared to the overall project goals. In one example, the actual value of carbon emission reduction may be dynamically calculated at each project phase and compared with the target value defined in the project goal.

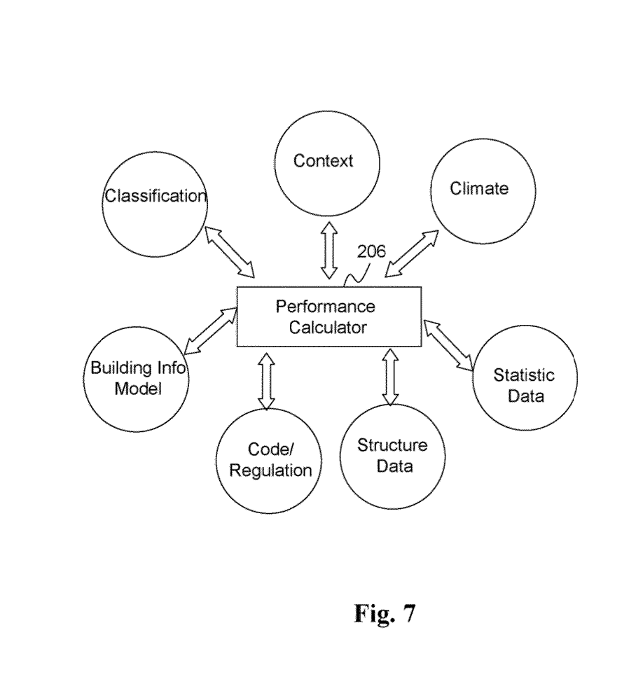

FIG. 7 illustrates exemplary information of a project for high performance design. The information includes, for example, the project context and site location, project climatic data, project classification data, project statistic data, project structure data, code/regulation data, building information model, etc. The performance calculator 206 may be responsible for performing the analysis and synthesis defined in each design task based on the information of the project retrieved from the database 104. Additionally or optionally, supporting information necessary for completing the analysis and synthesis may be determined by the performance calculator 206 and obtained from the users.

The HPD apparatus 102 may include other optional modules such as but not limited to a client review module, a map module, a climate module, and a context module. The client review module may allow the project clients to log of sign-off meetings and record client awareness through a web-based form. The map module may mark the project location on a map based on address or coordinates and display any other ongoing or completed projects in the surrounding areas. It may also allow for the definition of the project site area. The climate module may provide graphic and statistical analysis of the project climatic data, such as temperature, humidity, solar radiation, and solar position. The context module may provide graphic and statistical analysis of the project context and site location, such as city map, immediate surrounding map, site plan, traffic data, etc.

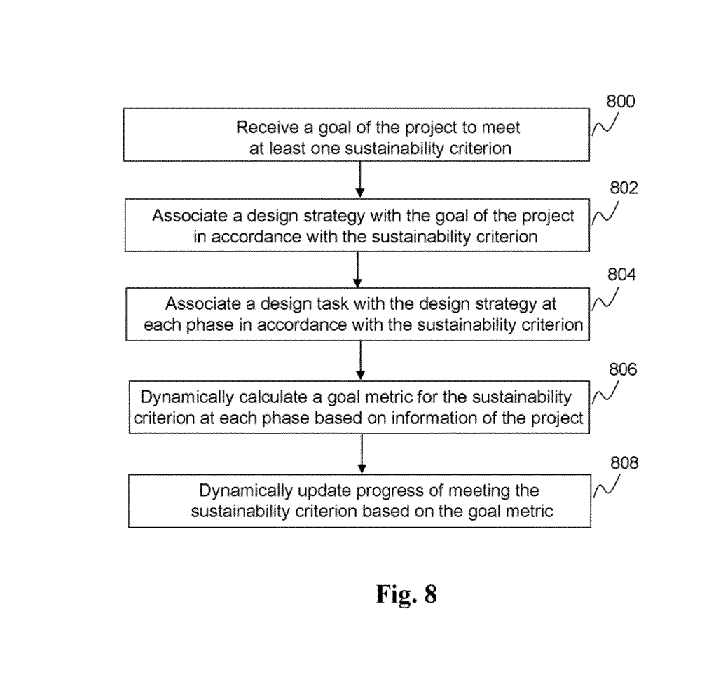

FIG. 8 is a flowchart of an exemplary process of high performance design, according to an embodiment of the present teaching. Beginning at block 800, a goal of the project to meet at least one sustainability criterion is received. As described above, this may be performed by the project goal module 200 of the apparatus 102. At block 802, processing may continue where a design strategy is associated with the goal of the project in accordance with the at least one sustainability criterion. The design strategy is created based on a common design approach. As described above, this may be performed by the design strategy module 202 of the apparatus 102. At block 804, a design task is associated with the design strategy at each phase of the project in accordance with the at least one sustainability criterion. The design task is created to implement the design strategy. As described above, this may be performed by the design task module 204 of the apparatus 102. At block 806, processing may continue where a goal metric is dynamically calculated for the at least one sustainability criterion at each phase of the project based on information of the project from a database. At block 808, progress of meeting the at least one sustainability criterion is dynamically updated based on the calculated goal metric. As described above, blocks 806, 808 may be performed by the performance calculator 206 of the apparatus 102.

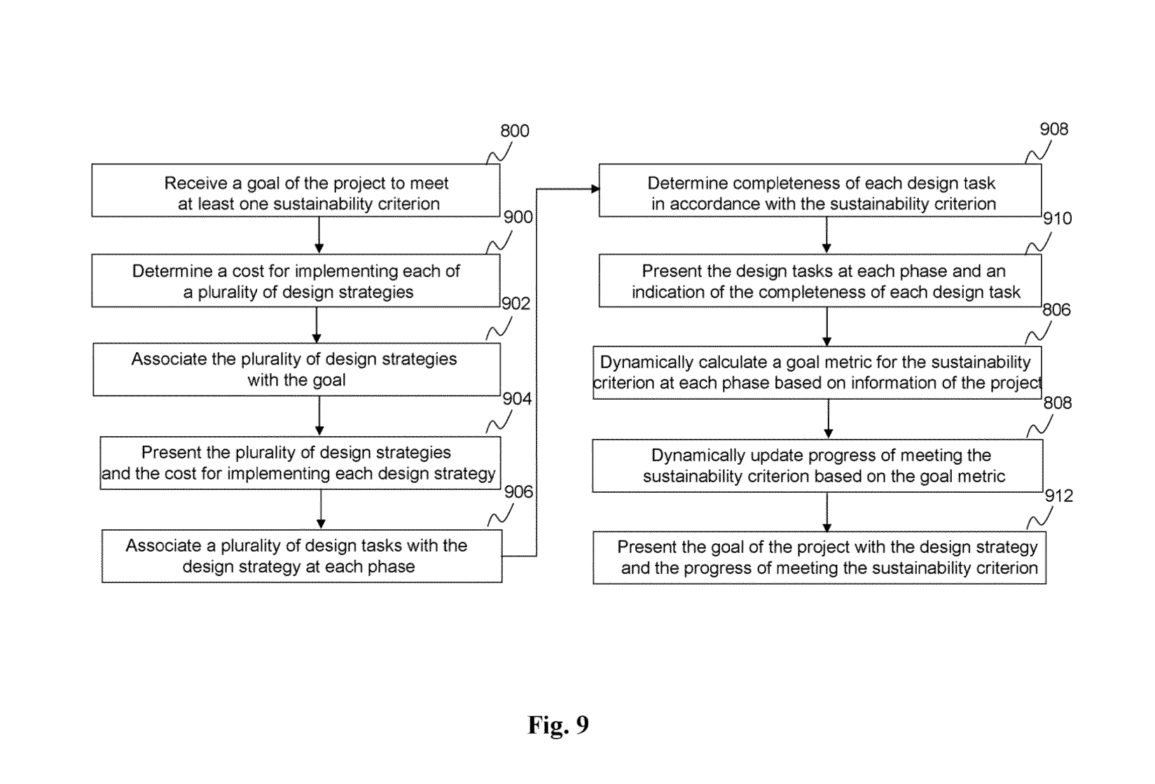

FIG. 9 is a more detailed flowchart of an exemplary process of high performance design of a project, according to an embodiment of the present teaching. Beginning at block 800, a goal of the project to meet at least one sustainability criterion is received. As described above, this may be performed by the project goal module 200 of the apparatus 102. At block 900, processing may continue where a cost for implementing each of a plurality of design strategies is determined. At block 902, the plurality of design strategies are associated with the goal of the project. At least some of the plurality of design strategies are selected from predefined templates. As described above, blocks 900, 902 may be performed by the design strategy module 202 of the apparatus 102. At block 904, the plurality of design strategies and the cost for implementing each design strategy are presented. As described above, this may be performed by the display 210 of the apparatus 102. At block 906, processing may continue where a plurality of design tasks are associated with the design strategy at each phase of the project. At least some of the plurality of design tasks are selected from predefined templates. At block 908, completeness of each of the plurality of design tasks is determined in accordance with the at least one sustainability criterion. As described above, blocks 906, 908 may be performed by the design task module 204 of the apparatus 102. At block 910, the plurality of design tasks at each phase of the project and an indication of the completeness of each design task are presented. As described above, this may be performed by the display 210 of the apparatus 102. At block 806, processing may continue where a goal metric is dynamically calculated for the at least one sustainability criterion at each phase of the project based on information of the project from a database. At block 808, progress of meeting the at least one sustainability criterion is dynamically updated based on the calculated goal metric. As described above, blocks 806, 808 may be performed by the performance calculator 206 of the apparatus 102. At block 912, the goal of the project with the associated design strategy and the progress of meeting the at least one sustainability criterion are presented. As described above, this may be performed by the display 210 of the apparatus 102.

Although the processing illustrated in FIG. 9 is illustrated in a particular order, those having ordinary skill in the art will appreciate that the processing can be performed in different orders. In one example, block 900 can be performed after block 908 or performed essentially simultaneously. In another example, block 904 can be performed after block 910 or performed essentially simultaneously. In still another example, blocks 902 and 906 can be performed prior to block 900.

To implement the present teaching, computer hardware platforms may be used as the hardware platform(s) for one or more of the elements described herein. The hardware elements, operating systems, and programming languages of such computers are conventional in nature, and it is presumed that those skilled in the art are adequately familiar therewith to adapt those technologies to implement the processing essentially as described herein. A computer with user interface elements may be used to implement a personal computer (PC) or other type of work station or terminal device, although a computer may also act as a server if appropriately programmed. It is believed that those skilled in the art are familiar with the structure, programming, and general operation of such computer equipment and as a result the drawings should be self-explanatory.

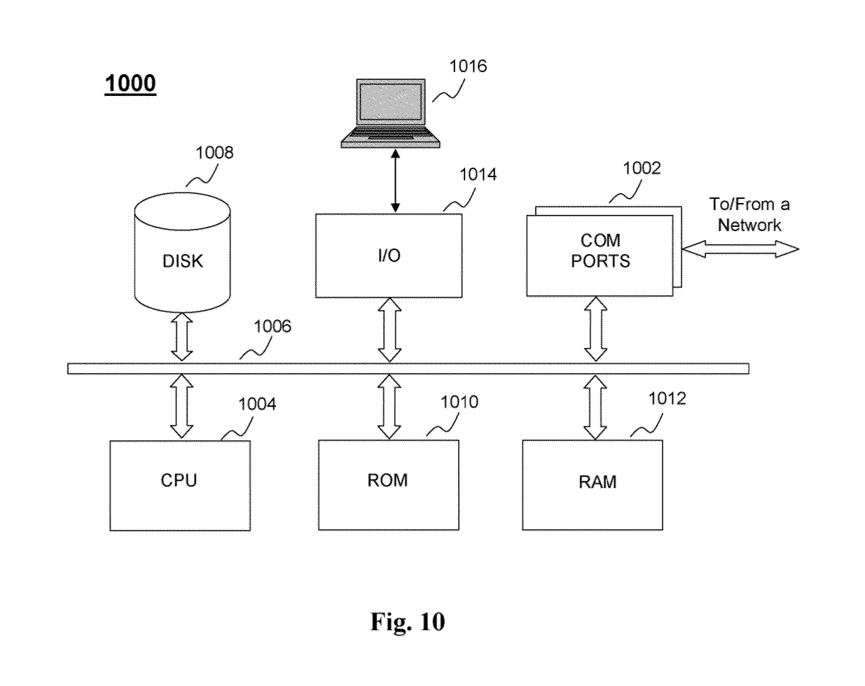

FIG. 10 depicts a general computer architecture on which the present teaching can be implemented and has a functional block diagram illustration of a computer hardware platform that includes user interface elements. The computer may be a general-purpose computer or a special purpose computer. This computer 1000 can be used to implement any components of the architecture as described herein. Different components of the apparatus 102, e.g., as depicted in FIGS. 1 and 2, can all be implemented on one or more computers such as computer 1000, via its hardware, software program, firmware, or a combination thereof. Although only one such computer is shown, for convenience, the computer functions relating to dynamic relation and event detection may be implemented in a distributed fashion on a number of similar platforms, to distribute the processing load.

The computer 1000, for example, includes COM ports 1002 connected to and from a network connected thereto to facilitate data communications. The computer 1000 also includes a central processing unit (CPU) 1004, in the form of one or more processors, for executing program instructions. The exemplary computer platform includes an internal communication bus 1006, program storage and data storage of different forms, e.g., disk 1008, read only memory (ROM) 1010, or random access memory (RAM) 1012, for various data files to be processed and/or communicated by the computer, as well as possibly program instructions to be executed by the CPU. The computer 1000 also includes an I/O component 1014, supporting input/output flows between the computer and other components therein such as user interface elements 1016. The computer 1000 may also receive programming and data via network communications.

Hence, aspects of the method for high performance design of a project as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teachings are amenable to a variety of modifications and/or enhancements. For example, although the implementation of various components described above may be embodied in a hardware device, it can also be implemented as a software only solution—e.g., an installation on an existing server. In addition, the units of the host and the client nodes as disclosed herein can be implemented as a firmware, firmware/software combination, firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

1. A method, implemented on at least one machine, each of which has at least one processor, storage, and a communication platform connected to a network for high performance design of a project, the method comprising:
receiving, by a project goal module implemented by the processor, a goal of the project to meet at least one sustainability criterion;
associating, by a design strategy module implemented by the processor, a design strategy with the goal of the project in accordance with the at least one sustainability criterion, the design strategy being created based on a common design approach;
associating, by a design task module implemented by the processor, a design task with the design strategy at each phase of the project in accordance with the at least one sustainability criterion, the design task being created to implement the design strategy;
dynamically calculating, by a performance calculator implemented by the processor, a goal metric for the at least one sustainability criterion at each phase of the project based on information of the project from a database; and
dynamically updating, by the performance calculator, progress of meeting the at least one sustainability criterion based on the calculated goal metric.

2. The method of claim 1 further comprising presenting the goal of the project with the associated design strategy and the progress of meeting the at least one sustainability criterion.

3. The method of claim 1, wherein associating a design strategy with the goal of the project comprises:
determining a cost for implementing each of a plurality of design strategies;
associating the plurality of design strategies with the goal of the project, at least some of the plurality of design strategies being selected from predefined templates; and
presenting the plurality of design strategies and the cost for implementing each design strategy.

4. The method of claim 1, wherein associating a design task with the design strategy comprises:
associating a plurality of design tasks with the design strategy at each phase of the project, at least some of the plurality of design tasks being selected from predefined templates;
determining completeness of each of the plurality of design tasks in accordance with the at least one sustainability criterion, and
presenting the plurality of design tasks at each phase of the project and an indication of the completeness of each design task.

5. The method of claim 1, wherein the at least one sustainability criterion includes at least one of energy, water, waste, human comfort, materials, certification, carbon, and any combination thereof.

6. The method of claim 1, wherein the common design approach includes at least one of reduction, absorption, reclamation, generation, and design/construction.

7. The method of claim 1, wherein the information of the project includes at least one of project context and site location, project climatic data, project classification data, project statistic data, project structure data, code/regulation data, and building information model.

8. An apparatus for high performance design of a project, comprising:
a project goal module implemented by a processor, configured to receive a goal of the project to meet at least one sustainability criterion;
a design strategy module implemented by the processor, configured to associate a design strategy with the goal of the project in accordance with the at least one sustainability criterion, the design strategy being created based on a common design approach;
a design task module implemented by the processor, configured to associate a design task with the design strategy at each phase of the project in accordance with the at least one sustainability criterion, the design task being created to implement the design strategy; and
a performance calculator implemented by the processor, configured to:
dynamically calculate a goal metric for the at least one sustainability criterion at each phase of the project based on information of the project from a database, and
dynamically update progress of meeting the at least one sustainability criterion based on the calculated goal metric.

9. The apparatus of claim 8, further comprising a display configured to present the goal of the project with the associated design strategy and the progress of meeting the at least one sustainability criterion.

10. The apparatus of claim 8, wherein
the design strategy module is further configured to:
determine a cost for implementing each of a plurality of design strategies, and
associate the plurality of design strategies with the goal of the project, at least some of the plurality of design strategies being selected from predefined templates; and
the apparatus further comprises a display configured to present the plurality of design strategies and the cost for implementing each design strategy.

11. The apparatus of claim 8, wherein
the design task module is further configured to:
associate a plurality of design tasks with the design strategy at each phase of the project, at least some of the plurality of design tasks being selected from predefined templates, and
determine completeness of each of the plurality of design tasks in accordance with the at least one sustainability criterion; and
the apparatus further comprises a display configured to present the plurality of design tasks at each phase of the project and an indication of the completeness of each design task.

12. The apparatus of claim 8, wherein the at least one sustainability criterion includes at least one of energy, water, waste, human comfort, materials, certification, carbon, and any combination thereof.

13. The apparatus of claim 8, wherein the common design approach includes at least one of reduction, absorption, reclamation, generation, and design/construction.

14. The apparatus of claim 8, wherein the information of the project includes at least one of project context and site location, project climatic data, project classification data, project statistic data, project structure data, code/regulation data, and building information model.

15. A machine-readable tangible and non-transitory medium having information for high performance design of a project recorded thereon, wherein the information, when read by the machine, causes the machine to perform the following:
receiving a goal of the project to meet at least one sustainability criterion;
associating a design strategy with the goal of the project in accordance with the at least one sustainability criterion, the design strategy being created based on a common design approach;
associating a design task with the design strategy at each phase of the project in accordance with the at least one sustainability criterion, the design task being created to implement the design strategy;
dynamically calculating a goal metric for the at least one sustainability criterion at each phase of the project based on information of the project from a database; and
dynamically updating progress of meeting the at least one sustainability criterion based on the calculated goal metric.

16. The medium of claim 15, further comprising presenting the goal of the project with the associated design strategy and the progress of meeting the at least one sustainability criterion.

17. The medium of claim 15, wherein associating a design strategy with the goal of the project comprises:
determining a cost for implementing each of a plurality of design strategies;
associating the plurality of design strategies with the goal of the project, at least some of the plurality of design strategies being selected from predefined templates; and
presenting the plurality of design strategies and the cost for implementing each design strategy.

18. The medium of claim 15, wherein associating a design task with the design strategy comprises:
associating a plurality of design tasks with the design strategy at each phase of the project, at least some of the plurality of design tasks being selected from predefined templates;
determining completeness of each of the plurality of design tasks in accordance with the at least one sustainability criterion, and
presenting the plurality of design tasks at each phase of the project and an indication of the completeness of each design task.

19. The medium of claim 15, wherein the at least one sustainability criterion includes at least one of energy, water, waste, human comfort, materials, certification, carbon, and any combination thereof.

20. The medium of claim 15, wherein the common design approach includes at least one of reduction, absorption, reclamation, generation, and design/construction.

21. The medium of claim 15, wherein the information of the project includes at least one of project context and site location, project climatic data, project classification data, project statistic data, project structure data, code/regulation data, and building information model.
